(19) United States
(12) Patent Application Publication
(10) Pub. No.: US 2025/0083955 A1
(43) Pub. Date: Mar. 13, 2025

(54) FULL TEMPERATURE RANGE SIMULATED ROTATED MOVING PRESSING SWING ADSORPTION (FTRSRMPSA) ENHANCED REACTION HYDROGEN GENERATION PROCESS FROM SHIFTED GAS

(71) Applicant: ZHEJIANG TECHAIRS CLOUD TECHNOLOGIES INC, JIAXING (CN)

(72) Inventors: LANHAI WANG, JIAXING (CN); YALING ZHONG, JIAXING (CN); YUN CHEN, JIAXING (CN); JINCAI TANG, JIAXING (CN); YUMING ZHONG, JIAXING (CN); YUEMING CAI, JIAXING (CN)

(21) Appl. No.: 18/810,675

(22) Filed: Aug. 21, 2024

Related U.S. Application Data
(63) Continuation of application No. PCT/CN2022/130759, filed on Nov. 9, 2022.

(30) Foreign Application Priority Data
Mar. 16, 2022 (CN) 202210260623.7

(51) Int. Cl. C01B 3/58

(52) U.S. Cl. CPC C01B 3/58; C01B 2203/042; C01B 2203/0475; C01B 2203/169

(57) ABSTRACT

Disclosed is a full temperature range simulated rotated moving pressure swing adsorption (FTrSRMPSA) enhanced reaction hydrogen generation process from a shifted gas. Multiple axial flow fixed bed adsorption reactors placed on a multi-channel rotary valve and ring-shaped rotary tray, and blended and loaded with medium and low-temperature shift catalysts and adsorbents are connected through a pipeline, and rotating directions and rotating speeds of the rotary valve and ring-shaped rotary tray are regulated. Therefore, gases complete mass and heat transfer of respective conversion reaction-adsorption and desorption regeneration steps by constantly coming in and going out of inlets and outlets of adsorption reactors to achieve a simulated rotated moving bed pressure swing adsorption enhanced reaction process. Hydrogen (H₂) product gases are directly obtained therefrom, and have the purity and yield of greater than or equal to 99.9-99.99% and 92-95%, respectively. High purity carbon dioxide (CO₂) is co-produced.

### TECHNICAL FIELD

The disclosure relates to the field of hydrogen (H₂) generation by hydrocarbon reforming, and in particular to a full temperature range simulated rotated moving pressure swing adsorption (FTRSRMPSA) enhanced reaction hydrogen generation process from a shifted gas.

### BACKGROUND

The shifted gas mainly refers to a mixed gas formed by impure compositions such as 30-60% of H₂ (volume ratio, similar in the following), 10-20% of CO, 10-20% of CO₂, unreacted water, hydrocarbons, other hydrocarbons and organic matter byproducts generated by catalytically reforming oxides from light hydrocarbon mixtures, alcohols and the like and steam at certain temperature and pressure and under the action of a reforming catalyst. CO and water are further subjected to a medium or low-temperature shift reaction at certain temperature and pressure and under the action of a shift catalyst to generate H₂ and CO₂, and then H₂ and CO₂ are then subjected to organic amine absorption or pressure swing adsorption (PSA) decarburization and PSA H₂ purification step to obtain a high purity H₂ product. Most typical light hydrocarbon raw material catalytic reforming hydrogen generation processes include: performing a reforming reaction first to generate a shifted gas; then subjecting the shifted gas to a shift reaction to generate a shifted gas rich in H₂ and CO₂; and then subjecting H₂ and CO₂ to an organic amine adsorption or PSA decarburization and PSA purification step to finally obtain the H₂ product. Although the hydrogen generation processes are mature, they have the shortcomings of long flow, large occupied area, high energy consumption and high equipment investment and cost. Therefore, the processes are technically transformed and updated at home and abroad, so that the flow is further simplified, and the occupied area and cost are reduced.

A method is to develop a dual functional composite catalyst and a matched integrated reactor and process. The core is to integrate the catalytic reforming reaction and the shift reaction in one reactor. This method has been applied to industrialized devices. For example, in a methanol-to-hydrogen process, because the catalytic reforming (cracking) reaction temperature and pressure of methanol steam are comparatively mild, most used catalysts are copper catalysts, the reaction temperature and pressure of which are equivalent to those of the catalyst based on ferric catalysts in the shift reaction. The heat balance processes of the two reactions are relatively close, so that the effect of achieving a dual functional catalyst is relatively ideal. The used catalysts in the catalytic reforming reaction process of methane and the like are high-temperature catalysts such as nickel catalysts. The reaction temperature is usually 700-900° C., which is far higher than the reaction temperature 100-300° C. needed by the medium and low temperature shift catalyst, resulting in substantial increase of the development difficulty of the dual functional catalyst.

Another method is a Sorption Enhanced Reaction Process (SERP for short) first invented by Air Products and Chemicals Inc (APCI), where a catalyst needed by reaction and an adsorbent needed by adsorption separation fill a same vessel, so that a reactor and an adsorber are integrated to form a sorption enhanced reactor which organically couples a chemical reaction with an adsorption separation process, which is completely different from the chemical reaction and adsorption separation respectively performed in two independent vessels: the reactor and the adsorber. The fundamental principle of the SER is to use the Le Chatelier thermodynamic principle, that is, when the system is (chemically) balanced, if any condition such as concentration, temperature and pressure of a balanced state is changed, the balance moves toward the direction where its change can be weakened. With respect to the catalytic reforming reaction and shift reaction system for generating H₂ by a reforming reaction of light hydrocarbon steam, when the concentrations of the reactants and products are in a state invariant with time, i.e., the system reaches the chemical (reaction) balance. If an adsorbent that selectively adsorbs the product CO₂ is added into the reaction system, the product CO₂ will be adsorbed immediately during the reaction, thereby breaking through the chemical balance. The reaction will proceed to the direction facilitating generation of H₂, so that the reaction approaches to completion. The sorption enhanced reaction process has the advantages that the reaction conversion ratio of the product yield or purity can be improved by improving the operating conditions, and the energy consumption and cost can be lowered by simplifying the process. The SERP developed by APCI first for pressure swing regeneration of hydrogen supply for fuel cells is used for methane steam conversion hydrogen generation. The used adsorbent is a high-temperature and water-resistant reversible chemical adsorbent (K₂CO₃-hydrotalcite) for selective adsorptive removal of CO₂ in a reaction region with the reaction temperature of 400-550° C. The adsorbed and saturated adsorbent is regenerated by the PSA cycle, a shift catalyst with a nickel active component loaded on aluminum oxide and the CO₂ chemical adsorbent fill the pressure swing adsorption enhanced reactor in a mixed manner to form the PSA enhanced reaction process of two axial flow fixed beds. One adsorption reactor is used to perform the conversion reaction-adsorption step and the other one is to perform the desorption-regeneration step of reverse pressure drop, vacuumizing purge, and reverse pressure rise. The operating pressure of the conversion reaction-adsorption step is 70-350 kPa. With respect to normal pressure depressurization and vacuumizing purge, the purge gas is 5-10% H2 steam. The desorption gas containing H₂, methane (CH₄), CO₂, and water is condensed to remove water and is outputted as a fuel gas. The pressurized gas is the feed gas of a methane and steam mixed gas, and the purity of the H₂ product obtained is 94.4%. The content of CH₄ is 5.6%, that of CO₂ is 40 ppmv, that of CO is 30 ppmv, and the methane conversion ratio reaches up to 73%, which is much higher than the conversion ratio 50-55% of the shifted gas prepared by the conventional catalytic conversion and shifting reaction two-step method experienced by steam methane catalytic reforming (SMR). The H₂ concentration in the shifted gas is increased, the load of subsequent PSA hydrogen purification is also reduced, and moreover, the hydrogen generation flow is simplified, and the investment and equipment and operation costs are lowered. However, the SERP developed by APCI has some obvious shortcomings: first, the process cannot product the H₂ product with higher purity directly, and further PSA hydrogen purification is still needed to obtain high purity H₂; second, the selected adsorbent is comparatively special, needs to be high-temperature and water-resistant, and a common commercial adsorbent is hardly used; third, the reaction temperature is too high: even the nickel catalyst in the SERP of APCI matching a CO₂ removing adsorbent can be decreased to about 500° C., which is much lower than 700-900° C. needed by a catalytic reforming nickel catalyst in a conventional two-section reaction and the energy consumption is less, however, it is unfavorable for the pressure swing adsorption process of CO₂ at higher temperature, and under low pressure adsorption, CO₂ is likely to be adsorbed and unsaturated to escape and enter the non-adsorbed phase gas, so that the CO₂ exceeds the standard severely in the shifted gas; fourth, PSA in the SERP actually only adsorbs at the lower temperature: desorption regeneration includes: performing normal pressure depressurization first, where the obtained depressurization gas as the feed gas returns to the other adsorption reactor in the conversion reaction-adsorption step, and reversely purging the bed with steam that contains 5-10% H₂ with the temperature lower than the reaction temperature, the obtained purge waste gas is condensed to remove water and is then taken as the fuel gas, so that the yield of H₂ has a certain loss; moreover, the used adsorbent is the chemical adsorbent, which is the consumptive adsorbent that is high in consumption and cannot be cyclically used like the conventional adsorbent; moreover, the thermal stability of the adsorbent itself will be greatly affected as a result of the temperature difference stress in the adsorption and desorption regeneration process at the higher temperature and steam content; and fifth, as the height-diameter ratio of the adsorption reactor in the SERP system is relatively less, it is quite unfavorable for the diffusion path of CO₂. Therefore, the SERP of methane steam reforming hydrogen generation by APCI hardly replaces the conventional SMR process. Therefore, APCI has developed another “temperature swing sorption enhanced reaction” process (TSSER) using temperature swing adsorption for water gas (shifted gas) hydrogen generation. As the ferric catalyst in the shifting reaction is relatively low in acting temperature, the temperature in the conversion reaction-adsorption step is 300-400° C., which is lower than 400-550° C. of the SERP, facilitating adsorption of CO₂. Therefore, the purity of the produced H₂ is further improved. However, the desorption regeneration temperature of the adsorbent reaches 500-550° C., the adsorbent will be greatly affected by the temperature difference stress in the adsorption and desorption regeneration process at higher temperature and steam content, the negative influence generated on the thermal stability of the adsorbent itself is higher than that of the SERP, and therefore, the replacing frequency of the adsorbent in the TSSER process is higher than that of the SERP, resulting in corresponding increase of the cost.

Regardless of the SERP or TSSER process, its critical technology is selection of the adsorbent and its corresponding process. Because the methane catalytic reforming reaction and the shifting reaction are high in speed and the endothermic and exothermic processes of the reactions themselves are different, the thermodynamic and dynamic adsorption rates of CO₂ will also be affected greatly, which further results in whether the conversion reaction-adsorption step is completed at the same time to change the chemical reaction balance moving all the way toward a direction favorable for H₂ generation. Thus, APCI has to use temperature and water-resistant chemical adsorbent with extremely high adsorption rate to match movement of the conversion reaction-adsorption balance system with the cost of short service life, high cost of the adsorbent and low purity of the H₂ product and yield. Other factors that affect the adsorption efficiency are neglected, such as air flow distribution, CO₂ adsorption mass transfer path, selection of the adsorbent and catalyst and corresponding filling mode or solid shape of the adsorbent/catalyst itself, adsorption and desorption cyclic operation mode and the like.

### SUMMARY

To overcome some problems in the previous existing adsorption enhanced reaction process in raw material (including methane or methanol) and steam catalytic reforming/conversion hydrogen generation process, the disclosure provides a novel process of full temperature range simulated rotated moving PSA (FTrSRMPSA) for CO₂ removal and H₂ purification by a pressure swing adsorption enhanced reaction of a shifted gas. In the process, based on the pressure swing adsorption enhanced reaction process (PSA-ERP), multiple axial flow fixed bed adsorption reactors placed at a center of a multi-channel rotary valve, placed on a ring-shaped rotary tray around the multi-channel rotary valve, and blended and loaded with medium and low-temperature shift catalysts and adsorbents are connected through a pipeline, and a rotating direction and a rotating speed (ω₁) of the rotary valve and a rotating direction and a rotating speed (ω₂) of the ring-shaped rotary tray are regulated by making full use of temperature and pressure of the shifted gas, properties of the medium-low temperature shift catalyst/adsorbent, the temperature range (90-150° C.) of components H₂ and CO₂ of the product, the adsorption separation coefficient within the pressure range of 0.2-1.0 MPa, and the difference on physical and chemical properties. Therefore, gases flowing through the channels of the rotary valve, the pipelines where the inlets and outlets of the channels of the rotary valve and the inlets and outlets of the adsorption reactors on the ring-shaped rotary tray are connected, and the adsorption reaction beds rotatably moving in the adsorption towers complete mass and heat transfer of respective conversion reaction-adsorption and desorption regeneration steps by constantly coming in and going out of positions of inlets and outlets of the adsorption reactors with rotation of the adsorption reaction beds, so that the shifted gas reaction balance tends to move toward a complete reaction direction therewith to further form a “simulated rotated moving bed” PSA enhanced reaction process, which achieves the simulated rotated moving bed pressure swing adsorption enhanced reaction process based on axial flow fixed bed pressure swing adsorption. The process is suitable for working conditions where corresponding flow, component concentration, pressure or temperature of the shifted gas fluctuate while achieving “double heights” of yield and purity and avoiding deep adsorption, makes full use of various advantages of the axial flow fixed bed pressure swing adsorption and related art including fixed bed pressure swing sorption enhanced reaction (SERP), fixed bed pressure swing sorption enhanced reaction (TSSER), rotated wheel adsorption and simulated moving bed, and overcomes defects in the existing technical processes. A specific solution of the process is as follows:

A full temperature range simulated rotated moving pressure swing adsorption (FTrSRMPSA) enhanced reaction hydrogen generation process from a shifted gas is provided, where the full temperature range simulated rotated moving pressure swing adsorption enhanced reaction process (FTrSRMPSA-ERP) system is formed by n (a natural number in a range of 2≤n≤10) adsorption reactors (towers) loaded with a medium-low temperature shift catalyst and a compound adsorbent blended in a certain proportion, having an axial flow fixed bed adsorption reactors (towers) with a certain height-diameter ratio and placed on a ring-shaped rotary tray at a rotating speed (ω₂, in second(s)/r), an m (a natural number in a range of 5≤m≤36)-channel rotary valve, placed at a center of the ring-shaped rotary try and rotating at a rotating speed (ω₁, in second(s)/r), a material pipeline where material gases outside the rotary valve and a system come in and go out, a process pipeline connected from a built-in pipeline of the ring-shaped tray to a position between the adsorption reactors (towers) and the rotary valve, and a driving mechanism correspondingly driving the ring-shaped rotary tray and the rotary valve in rotating directions and regulating rotating speeds (ω₁ and ω₂) thereof, a buffer tank, a condenser/or heat exchanger/or superheater/or pressurizer/or vacuum pump, where the pipeline connecting inlets and outlets of the adsorption reactors (towers) and an inlet and an outlet of the m-channel rotary valve is connected to the built-in pipeline pre-arranged in the ring-shaped rotary tray to form the process pipeline and has the same number m as that of the channels of the rotary valve; positions of the material gas coming in and going out of the FTrSRMPSA-ERP system are fixed by distributing the rotary channels of the m-channel rotary valve, the material gases thereof include a shifted gas as a feed gas (F), an H₂ product gas (H₂PG), a purge gas (P) outside the system, a final repressurization gas (FR) outside the system, and a desorption gas (D) formed by a depressurization gas (D) or/and a vacuumizing gas (V) or/and a purge waste gas (PW) and are correspondingly connected to devices including the buffer tank, condenser/or heat exchanger/or superheater/or pressurizer/or vacuum pump; the position where the process gases flow in the process pipeline connected through the built-in pipeline in the ring-shaped rotary tray between the inlet and outlet of the m-channel rotary valve and the inlets and outlets of the adsorption reactors (towers) changes alternately in a mobile manner;

the process gases flow in the FTrSRMPSA-ERP system, including the feed gas (F), a pathwise pressure release gas (PP), the purge gases (P) inside and outside the system, an equalization drop gas (ED), the desorption gas (D) formed by the depressurization gas (D) or/and the vacuumizing gas (V) or/and the purge waste gas (PW), an equalization rise gas (ER), the final repressurization gas (FR), and the product hydrogen (H₂PG); a cyclic process of specific adsorption and desorption is as follows: the feed shifted gas (F) outside the FTrSRMPSA-ERP system enters feed gas (F) inlets of the multi-channel rotary valve, and enters a conversion reaction-adsorption (CR-A) step from bottoms of the adsorption reactors (towers) through the process pipeline connected to the feed gas (F) channels and the outlet of the rotary valve, the built-in pipeline of the ring-shaped rotary tray, and corresponding inlets of the one or more axial flow fixed adsorption reactors (towers) in a conversion reaction-adsorption (CR-A) state on the ring-shaped rotary tray; as continuously stepped in a matched manner by regulating the rotating direction and the rotating speed (ω₁) of the m-channel rotary valve and the rotating direction and the rotating speed (ω₂) of the ring-shaped rotary tray, non-adsorbed phase gases flowing out from tops of the adsorption reactors (tower) just enter channels of the H₂ product gas (H₂PG) of the m-channel rotary valve through the process pipeline and flow out from the channel of the H₂ product gas (H₂PG) of the rotary valve to form the H₂ product gas (H₂PG) that enters the H₂ product gas buffer tank and is then outputted; after the conversion reaction-adsorption (CR-A) step is completed by the adsorption reactors (towers) in the conversion reaction-adsorption (CR-A) state, as the m-channel rotary valve and the ring-shaped rotary tray rotate continuously to step, and/or the adsorption reactors (towers) after the conversion reaction-adsorption (CR-A) perform a pathwise pressure release (PP) or equalization drop (ED) step on one or more adsorption reactors (towers) in a purge (P) or equalization rise (ER) state through the process pipeline inside the system; the adsorption reactors (towers) after the pathwise pressure release (PP) or equalization drop (ED) step enter a depressurization (D) or/and vacuumizing (V) or/and purge (P) step as the m-channel rotary valves and the ring-shaped rotary tray rotate continuously to step; the desorption gas (D) formed by the depressurization gas (D) or/and vacuumizing gas (V) or/and purge waste gas (PW) flowing out from the adsorption towers flow out through the built-in pipeline or an external pipeline of the ring-shaped rotary tray and depressurization gas (D)/vacuumizing gas (V)/purge waste gas (PW) channel of the rotary valve and the outlet end thereof and flow through the desorption gas (D) buffer tank, and the desorption gas (D) is a CO₂-enriched gas, or the desorption gas directly enters the condenser to remove a water and co-produce high concentration CO₂, or enters a decarburization and H₂ recovery step, or returns to a natural gas/light hydrocarbon steam reforming reaction to a step of preparing the shifted gas or feed gas as carbon-hydrogen ratio adjustment; the adsorption reactor (tower) after the depressurization (D) or/and vacuumizing (V) or/and purge (P) step enters an equalization rise (ER) or waiting area (-) step as the m-channel rotary valve and the ring-shaped rotary ring rotate continuously to step; the process gases flow out from the adsorption reactor (tower) in the ED step and enter the adsorption reactor (tower) in the ER step through the built-in pipeline of the ring-shaped rotary tray and the ED channel of the rotary valve for equalization, so that the adsorption reactor (tower) in the ER or/and waiting area (-) step is finished till the pressure of the adsorption reactor (tower) in the ER step is equal to the pressure in the adsorption reactor (tower) in the ED step, and enters a final repressurization (FR) step as the m-channel rotary valve and the ring-shaped rotary ring rotate continuously to step; the H₂ product gas (H₂PG) or the feed shifted gas (F), as the final repressurization gas (FR), flow through the FR channels of the m-channel rotary valves and the built-in pipeline of the ring-shaped rotary tray to enter the adsorption reactors (towers) for pressure inflation till the pressure in the adsorption reactor (tower) reaches the conversion reaction-adsorption pressure needed by the CR-A step, and a cyclic operation of conversion reaction-adsorption and desorption next round is prepared; each adsorption reactor (tower) performs one or more step and each step and is matched by regulating the rotating direction and the rotating speed (ω₁) of the m-channel rotary valve and the rotating direction and the rotating speed (ω₂) of the ring-shaped rotary tray, so that the m channels in the rotating m-channel rotary valve are connected to time scales in the cyclic operation of conversion reaction-adsorption and desorption of the n rotating adsorption reactors (towers) in the ring-shaped rotary tray end to end to form a circle, and integrally form operating cyclicity of the conversion reaction-adsorption and desorption process of the PSA enhanced reaction; all material gases and process gases are uniformly and alternately distributed in m round (slotted) channels in the m-channel rotary valve and the built-in pipeline in the ring-shaped rotary tray and the adsorption reactors (towers) in the system, in the PSA enhanced reaction process of one cyclic period, the steps in the conversion reaction-adsorption and desorption process are simultaneously performed on the adsorption reactors (towers) on the rotating m-channel rotary valve (ω₁) and the correspondingly rotating adsorption reactors (towers) on the ring-shaped rotary tray (ω₂) connected, respectively; the positions of the process gases coming in and going out of the adsorption reactors (towers) change constantly by matching the rotating direction and the rotating speed (ω₁) of the m-channel rotary valve and the rotating direction and the rotating speed (ω₂) of the ring-shaped rotary tray, so that each adsorption reactor (tower) repeats the conversion reaction-adsorption and desorption step, and equivalently, each fixed bed adsorption reactor (tower) completes respective conversion reaction-adsorption and desorption step while the m-channel rotary valve and the ring-shaped rotary tray rotate, so as to form “a simulated rotated moving bed” PSA enhanced reaction process; and therefore, the product H₂ product gas (H₂PG) is obtained from the shifted gas, where the purity of the gas product is greater than or equal to 99.99%, and the yield thereof is greater than or equal to 92%.

Further, the full temperature range simulated rotated moving pressure swing adsorption (FTrSRMPSA) enhanced reaction hydrogen generation process from a shifted gas is provided, where the step of regulating and matching the rotating directions of the m-channel rotary valve and the ring-shaped rotary tray and the rotating speeds thereof (ω₁ and ω₂) includes: 1) homodromous synchronizing, where the m-channel rotary valve and the ring-shaped rotary tray rotate homodromously in the clockwise or anticlockwise direction and ω₁=ω₂/≠0; 2) homodromous asynchronizing, where the m-channel rotary valve and the ring-shaped rotary tray rotate homodromously in the clockwise or anticlockwise direction and ω₁>ω₂ or ω₁<ω₂ or ω₁≠0/ω₂=0 or ω₁=0/ω₂≠0; 3) heterodromous synchronizing, where the m-channel rotary valve and the ring-shaped rotary tray rotate heterodromously in the clockwise/anticlockwise direction or anticlockwise/clockwise direction and ω₁=ω₂/≠0; and 4) heterodromous asynchronizing, where the m-channel rotary valve and the ring-shaped rotary tray rotate heterodromously in the clockwise/anticlockwise direction or anticlockwise/clockwise direction and ω₁>ω₂ or ω₁<ω₂ or ω₁≠0/ω₂=0 or ω₁=0/ω₂≠0, and preferably, in the homodromous rotation in the clockwise or anticlockwise direction in the homodromous synchronizing and homodromous asynchronizing, ω₁≠0/ω₂=0 or ω₁=0/ω₂≠0.

Even further, the full temperature range simulated rotated moving pressure swing adsorption (FTrSRMPSA) enhanced reaction hydrogen generation process from a shifted gas is provided, where a combination of the closed cyclic operation step of conversion reaction-adsorption and desorption of the FTrSRMPSA-ERP system further includes: 1-2 time pressure equalization, 1-2 batch purge, 1 time vacuumizing, 1-2 time variable temperature pressure swing adsorption of heating and cooled heat exchanging, 1 time mutual dislocation of pathwise pressure release and equalization drop, and 1 waiting area step; moreover, the number (n) of the adsorption reactors (towers) and the number (m) of the corresponding m-channel rotary valve are increased, the height (radius)-diameter ratio (h/r) of the adsorption towers is decreased, and the rotating speeds of the m-channel rotary valve and the ring-shaped rotary tray are enough high in speed or enough short in rotating period, a separation effect of products H₂ and CO₂ in a shifted gas adsorption enhanced reaction system infinitely approaches a “steady” mass transfer separation process of the moving bed, the shifted gas reaction balance tends to move toward a complete reaction direction therewith, and the purity of the H₂ product gas (H₂PG) finally obtained is greater than or equal to 99.999%, and the product yield is greater than or equal to 95%.

Even further, the full temperature range simulated rotated moving pressure swing adsorption (FTrSRMPSA) enhanced reaction hydrogen generation process from a shifted gas is provided, where the shifted gas (F) as a raw material is a mixed gas formed by 30-60% of H₂ (v), 10-20% CO (v), and 10-20% CO₂ (v) obtained by catalytically reforming or thermally cracking methane or methanol or other hydrocarbons by steam, unreacted water, hydrocarbons and other hydrocarbons or organic matter byproduct impurities, and the temperature of the shifted gas is 90-150° C., the pressure thereof is 0.2-1.0 MPa, and the flow thereof is 100-20000 Nm³/h.

Even further, the full temperature range simulated rotated moving pressure swing adsorption (FTrSRMPSA) enhanced reaction hydrogen generation process from a shifted gas is provided, where the purge gas (P) is the pathwise pressure release gas (PP) inside the system or the H₂ product gas (H₂PG) outside the system, and is purged in batches through one or more holes in the channels (slots) of the m-channel rotary valve, at most 4 holes are formed, the pathwise pressure release gas (PP) inside the system is preferably taken as the purge gas (P), and the yield of the H₂ product gas (H₂PG) reaches 93% or above.

Even further, the full temperature range simulated rotated moving pressure swing adsorption (FTrSRMPSA) enhanced reaction hydrogen generation process from a shifted gas is provided, where in the depressurization (D) step, desorption is performed in a vacuumizing manner; the additionally arranged vacuum pump is connected to a material flow pipeline of the m-channel rotary valve where the desorption gas flows out or is directly connected to the external pipeline connected to the outlet end of the adsorption tower on the ring-shaped rotary tray, and a control valve is arranged on the external pipeline, and preferably, the vacuum pump is directly connected to the external pipeline connected to the outlet end of the adsorption tower on the ring-shaped rotary tray and the control valve is arranged on the external pipeline.

Even further, the full temperature range simulated rotated moving pressure swing adsorption (FTrSRMPSA) enhanced reaction hydrogen generation process from a shifted gas is provided, where the final repressurization gas (FR) is the feed shifted gas (F) or the H₂ product gas (H₂PG) outside the system, and under a working condition that the purity of the H₂ product gas (H₂PG) is required to be greater than or equal to 99.99%, the H₂ product gas (H₂PG) is preferably used as the final repressurization gas (FR).

Even further, the full temperature range simulated rotated moving pressure swing adsorption (FTrSRMPSA) enhanced reaction process from a shifted gas is provided, where the n loaded blended catalysts/adsorbents in the FTrSRMPSA-ERP system are formed by stacking ferric medium shift catalysts and lithium-carbon molecular sieves/activated carbon particles in a proportion of 1:(1-1.5) at an interval, or composite catalytic adsorbent particles of ferric active component loading carbon nanotubes (CNTs) or carbon fibers (CNFs)/activated carbon (AC)/aluminum oxide, or cellular and bundled regular composite catalytic adsorbents formed by high polymer organic matters or carbon nanotubes or carbon fibers or formed by loading ferric active components by taking silicate as a base material, and preferably, the catalysts/adsorbents are formed by stacking ferric medium shift catalysts and lithium-carbon molecular sieves/activated carbon particles in a proportion of 1:1.1 at an interval or the bundled and cellular regular composite adsorbents formed by high polymer organic matters or carbon nanotubes or carbon fibers or formed by loading ferric/lithium active components by taking silicate (containing silicon fluoride, ceramics, and glass fibers) as the base material.

The disclosure has the following beneficial effects:
(1) Through the disclosure, the fixed bed shift reaction and the fixed bed PSA separation process in hydrocarbon (oxygen) compound hydrogen generation can be coupled and simulated to become a full temperature range simulated rotated moving pressure swing adsorption enhanced reaction hydrogen generation process, and the H₂ product gas can be directly obtained with high purity and high yield under medium and low-temperature (90-150° C.) and low-pressure (0.2-1.0 MPa) operating conditions, where the purity is greater than or equal to 99.99% and the yield is greater than or equal to 92-95%, which breaks through a limitation that existing adsorption enhanced reaction hydrogen production processes cannot obtain the H₂ product gas with high purity and high yield directly, so that the investment and cost are further lowered.
(2) By regulating and matching the rotating directions and the rotating speeds (ω₁ and ω₂) of the multi-channel rotary valve and the ring-shaped rotary tray, a multi-combined and multi-step adsorption and desorption PSA cyclic operation can be achieved in the conventional fixed bed adsorption reactor (tower) process, so that the shifted gas reaction balance tends to move toward a complete reaction direction therewith to further form the “simulated rotated moving bed” PSA enhanced reaction process, which achieves the simulated rotated moving bed PSA enhanced reaction process based on the axial flow fixed bed PSA enhanced reaction. It can be further adjusted flexibly according to the technical index requirements of the product H₂ and cover existing moving bed PSA processes including a process of combining the multi-channel rotary valve and the conventional fixed bed PSA, a typical moving bed process of a fan-shaped adsorption chamber rotating wheel PSA or fast wheel PSA, and the like.
(3) In the disclosure, the numbers of program control valves and regulate valves of the conventional fixed bed PSA enhanced reaction hydrogen generation device are greatly reduced, and moreover, the complexity of manufacturing the fast wheel PSA device is also reduced. It can replace the device imported abroad, so that the investment and production cost are further lowered.
(4) The disclosure fits working conditions with relatively large fluctuations of feed gas, including fluctuations of components, concentration, pressure, flow, and the like by regulating and matching the rotating directions and the rotating speeds (ω₁ and ω₂) of the multi-channel rotary valve and the ring-shaped rotary tray. The process features high operating flexibility, diverse blending forms of catalysts/adsorbents, long service life, and low production cost.
(5) In the disclosure, according to the feed gas and its fluctuating working conditions and the requirements on the technical indexes of the product H₂, the height-diameter ratio of the adsorption reactors (towers) are adjusted and designed by adjusting and matching the rotating directions and rotating speeds ω₁ and ω₂ of the rotary valve and the ring-shaped rotary tray and the adsorption pressure and temperature, so that radial diffusion in the axial flow fixed bed is ignored and a mature mass transfer mode of the axial flow fixed bed is satisfied. The influence of diffusion of the axial flow is increasingly less with acceleration of ω₂ and reduction of the height-diameter ratio, so that the mass transfer process in the adsorption tower further approaches the “steady” effect of the moving bed represented by a circulating bed. The purity and yield of the H₂ product further approach “double heights”.

### BRIEF DESCRIPTION OF FIGURES

FIG. 1 is a flowchart of an embodiment 1 of the disclosure.

FIG. 2 is a flowchart of an embodiment 2 of the disclosure.

### DETAILED DESCRIPTION

In order to make persons skilled in the art better understand the solutions of the disclosure, the technical solutions in the embodiments of the disclosure will be described clearly and completely below in conjunction with drawings.

### Embodiment 1

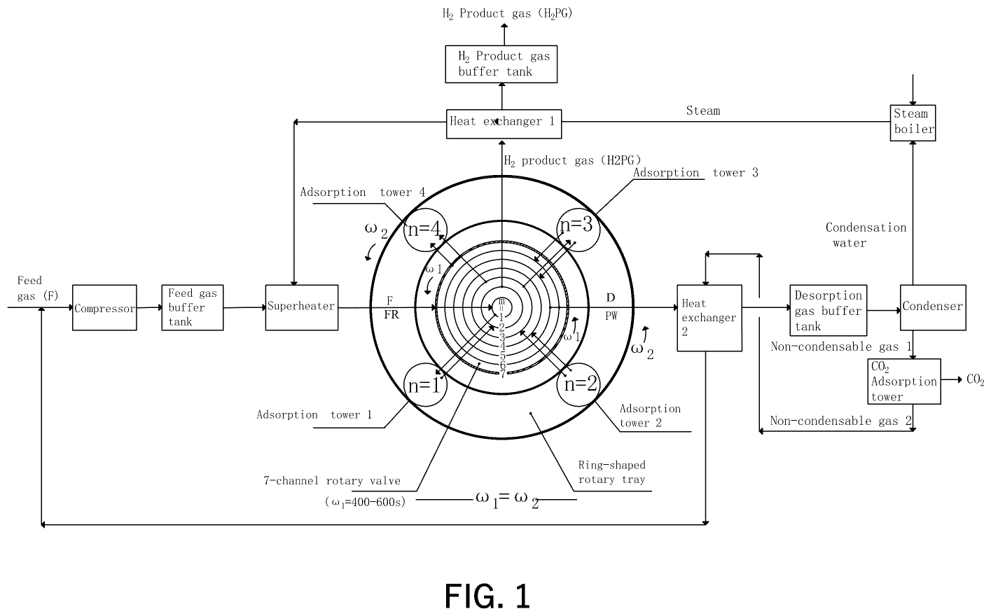

As shown in FIG. 1, a full temperature range simulated rotated moving pressure swing adsorption (FTrSRMPSA) enhanced reaction hydrogen generation process from a shifted gas is provided. A full temperature range simulated rotated moving bed is an FTrSRMPSA-ERP system which includes 4 axial flow fixed bed adsorption towers (n=4) with the height-diameter ratio of 2-3, loaded with blended catalysts/adsorbents formed by a ferric medium-temperature swing shift catalyst and lithium carbon molecular sieve/activated carbon mixed adsorbent stacked in a proportion of 1:1.2 at an interval, and placed on a ring-shaped rotary tray at the rotating speed of ω₂=400-600 s; a corresponding driving mechanism; a 7-channel rotary valve at the rotating speed of ω₁=400-600 s, having 7 channels (m=7) and placed at a center of the ring-shaped tray; a material pipeline where a material gas outside the 7-channel rotary valve and a system formed by an H₂ product gas (H₂PG), a feed gas (F), and a desorption gas (D) formed by a depressurization gas (D) and a purge waste gas (PW) comes in and goes out; a process pipeline connected from a built-in pipeline of the ring-shaped rotary tray to a position between the adsorption towers and an inlet and an outlet of the 7-channel rotary valve; and an H₂ product gas (H₂PG)/desorption gas (D) buffer tank, a compressor, a superheater, a heat exchanger 1/heat exchanger 2, a condenser, a steam boiler, and a CO₂ adsorption tower. The rotating speed ω₁ of the 7-channel rotary valve is equal to the rotating speed ω₂ of the ring-shaped rotary tray (both are 400-600 s), and the rotating direction is the anticlockwise direction, i.e., the rotary regulation mode of the two is homodromous synchronization. 7 channels in the 7-channel rotary valve respectively have the following effects: 4 channels are material gas channels where the feed gas (F) (for example, m=1), the H₂ product gas (H₂PG) (for example, m=2), and the desorption gas (D) formed by the depressurization gas (D) (for example, m=5) and the purge waste gas (PW) (for example, m=6), and the feed gas (F) as the final repressurization gas (FR) (for example, m=7) circulate. 1 (for example, m=3) channel is process gas channel where the equalization drop gas (ED) and the equalization rise gas (ER) circulate. 1 (for example, m=4) channel is process flow channel where the pathwise pressure release gas (PP) as the purge gas (P) circulates. The compressor, the feed gas (F) buffer tank, and the superheater which are interconnected are sequentially arranged between the feed gas (F) material pipeline and the inlet end of the 7-channel rotary valve outside the system. The material pipeline where the desorption gas (D) formed by the depressurization gas (D) and the purge waste gas (PW) flows out from the outlet end of the 7-channel rotary valve is successively connected to the heat exchanger 2, the desorption gas (D) buffer tank, the condenser, the non-condensable gas 1 and CO₂ adsorption tower, and the non-condensable gas 2 and feed gas (F) material pipeline. The condensate water is connected to the steam boiler, and the steam is connected to the heat exchanger 1 and the superheater. The material pipeline of the H₂ product gas (H₂PG) flowing out from the outlet end of the 7-channel rotary valve is connected to the H₂ product gas (H₂PG) buffer tank. The feed gas (F) is the hydrogen-containing shifted gas obtained by subjecting natural gas to steam catalytic reforming, with typical components of hydrogen (H₂) with the concentration of 55% (v/v), carbon monoxide (CO) with the concentration of 15%, carbon dioxide (CO₂) with the concentration of 5%, steam with the concentration of 15%, methane (CH₄) with the concentration of 8%, and light hydrocarbon components with the concentration of 2%. The temperature of the shifted gas pressurized by the compressor to 0.6-0.8 MPa and overheated by the feed gas (F) buffer tank and the superheater is 120-130° C. The shifted gas enters the material channel (for example, m=1) of the feed gas (F) from a through hole material pipeline connected to the inlet end of the channel of the 7-channel rotary valve, enters the adsorption tower 1 through the process pipeline connected to the built-in pipeline of the ring-shaped rotary tray through the outlet of the through hole of the channel and connected to the inlet end of the adsorption tower 1, and is subjected to a conversion reaction adsorption (CR-A) step of a conversion reaction (CR) and an adsorption (A) reaction. A non-adsorbed phase gas flowing out from the outlet end of the adsorption tower 1 flows through the process pipeline connected to the adsorption tower 1, the built-in pipeline of the ring-shaped rotary tray, and the through hole of the material channel (for example, m=2) of the 7-channel rotary valve. The H₂ product gas (H₂PG) with the hydrogen (H₂) purity greater than or equal to 99.99% (v/v) flowing out from the product gas (PG) material pipeline connected to the 7-channel rotary valve and the H₂ product gas (H₂PG) buffer tank enters the H₂ product gas (H₂PG) buffer tank and is directly delivered outside. After the CR-A step is finished, with homodromous synchronous rotation of the 7-channel rotary valve and the ring-shaped rotary tray in the anticlockwise direction, the adsorption tower 1 rotates to the position of the adsorption tower 2 in FIG. 1 for the equalization drop (ED) and pathwise pressure release (PP) operating steps. The equalization drop gas (ED) flowing out from the adsorption tower 1 flows through the built-in pipeline of the ring-shaped rotary tray, the equalization drop (ED) channel (for example, m=3) of the 7-channel rotary valve and the outlet end thereof, and the process pipeline where the built-in pipeline of the ring-shaped rotary tray is connected to the inlet end of the adsorption tower 4 just in the equalization rise (ER) step and enters the adsorption tower 4 (in this case, the position of the tower has stepped to the initial position of the adsorption tower 1) for pressure equalization till the pressures in the adsorption tower 1 and the adsorption tower 4 are equal (both are 0.2-0.3 MPa). Then, in the process that the ring-shaped rotary tray and the 7-channel rotary valve continue to rotate homodromously and synchronously, the adsorption tower 1 finishing the ED step enters the PP step, and the PP gas flowing out therefrom as the purge gas (P) flows through the built-in pipeline of the ring-shaped rotary tray and the PP channel (for example, m=4) of the 7-channel rotary valve and the outlet end thereof and the process pipeline where the built-in pipeline of the ring-shaped rotary tray is connected to the outlet end of the adsorption tower 3 just in the purge (P) step and enters the adsorption tower 3 (in this case, the position of the tower has stepped to the initial position of the adsorption tower 4) for purge (P). As the ring-shaped rotary tray and the 7-channel rotary valve continue to rotate homodromously and synchronously, the position of the adsorption tower 1 finishing the PP step moves to the initial position of the adsorption tower 3 in FIG. 1 for the depressurization (D) step. The depressurization gas (D) reversely dropped to normal pressure and flowing out from the adsorption tower 1 as the desorption gas (D) flows through the built-in pipeline of the ring-shaped rotary tray and the depressurization gas (D) channel (for example, m=5) of the 7-channel rotary valve and the outlet end thereof, is cooled by the heat exchanger 2 and flows through the desorption gas (D) buffer tank to enter the condenser. The non-condensable gas 1 generated from the condenser directly enters the CO2 adsorption tower taking an organic amine as the adsorbent for decarburization to generate a high concentration by-product CO₂. The non-condensable gas 2 generated therefrom heated by heat exchange with the depressurization gas (D) in the heat exchanger 2 directly returns to the feed gas (F) to further recovery H₂ and CO therein. The condensate generated by the condenser is water which enters the steam boiler to form steam, exchanges heat in the heat exchanger 1 and then enters the superheater, and together with the feed gas (F), forms a superheated feed gas which enters the FTrSRMPSA-ERP system. The proportion of the amount of circulating steam and the newly supplemented water (steam) can be adjusted according to a proportional requirement of H(H₂O):C(CO) in the feed gas (F) in the conversion reaction, so that the conversion reaction and CO₂ adsorption reach a complete dynamic balance. As the ring-shaped rotary tray and the 7-channel rotary valve continue to rotate homodromously and synchronously, the adsorption tower 1 finishing the D step enters the P step in the continuous moving process, the PP gas flowing out from the adsorption tower 4 just in the PP step as the purge gas (P) enters the adsorption tower 1 for purge (P), the purge waste gas (PW) generated therein flows through the built-in pipeline of the ring-shaped rotary tray and the PW channel (for example, m=6) of the 7-channel rotary valve and the outlet end thereof as the desorption gas (D), and the desorption gas cooled by the heat exchanger 2 flows through the desorption gas (D) buffer tank and is treated according to a treatment flow of the desorption gas (D). As the ring-shaped rotary tray and the 7-channel rotary valve further continue to rotate homodromously and synchronously, the position of the adsorption tower 1 finishing the P step moves to the initial position of the adsorption tower 4 in FIG. 1 to enter the ER and FR steps. The ED gas flowing out from the adsorption tower 3 just in the ED step flows through the built-in pipeline of the ring-shaped rotary tray and the ED/ER common channel (for example, m=3) of the 7-channel rotary valve and the outlet end thereof, flows out, and flows through the built-in pipeline of the ring-shaped rotary tray to enter the adsorption tower 1 for ER, so that the pressure in the adsorption tower 1 rises from normal pressure to be equal to the pressure in the adsorption tower 3 in the ED step (both are 0.2-0.3 MPa). As the ring-shaped rotary tray and the 7-channel rotary valve continue to rotate homodromously and synchronously, the adsorption tower 1 finishing the ER step receives the feed gas (F) outside the system as the FR gas which flows through the FR channel (for example, m=7) of the 7-channel rotary valve and inflates the inlets of the built-in pipeline of the ring-shaped rotary tray and the adsorption tower 1, so that the pressure in the adsorption tower 1 rises to the pressure (0.6-0.8 MPa) needed by the CR-A step, thereby forming the intact PSA enhanced reaction close-looped cyclic operation of the adsorption tower 1, i.e., the CR-A-ED/PP-D/P-ER/FR steps. Then, the adsorption tower 1 enters the next conversion reaction adsorption and desorption closed-loop cyclic operation process. The material gases and process gases correspondingly coming in and going out of the adsorption towers 2, 3, and 4 are also subjected to corresponding conversion reaction adsorption and desorption closed-loop cyclic operation steps in the conversion reaction adsorption and desorption closed-loop cyclic operation process of the adsorption tower 1 as the ring-shaped rotary tray and the 7-channel rotary valve continue to rotate homodromously and synchronously and the 7-channel rotary valve periodically and alternatively switches the 7 channels to synchronously switch the in-out positions of the material or process gases of the adsorption towers. The closed-loop cyclic operation steps of each adsorption tower correspond to those of the other 3 adsorption towers. Therefore, the high purity hydrogen (H₂) product gas with the hydrogen purity greater than or equal to 99.99% is directly and continuously produced from the shifted gas having hydrogen (H₂) with the concentration of 55% (v/v), carbon monoxide (CO) with the concentration of 15%, carbon dioxide (CO₂) with the concentration of 5%, steam with the concentration of 15%, methane (CH₄) with the concentration of 8%, and light hydrocarbon components with the concentration of 2% as the feed gas. The yield of the product gas is greater than or equal to 92%. “Double heights” of high purity and high yield of the simulated rotated PSA process based on the axial flow fixed bed of the SERP are achieved.

### Embodiment 2

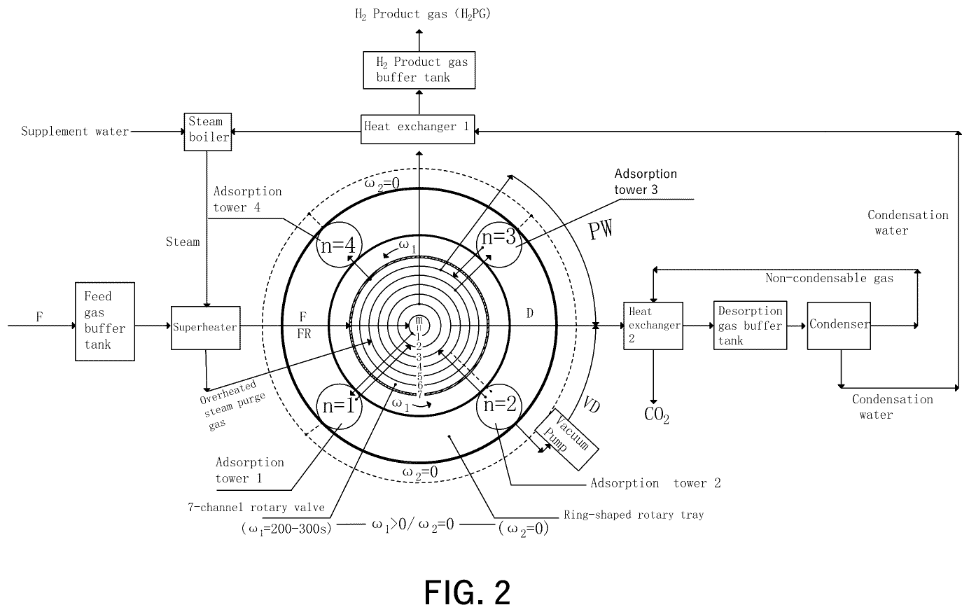

As shown in FIG. 2, based on embodiment 1, the shifted gas is the feed gas which is not pressurized by the compressor but is pressurized by a blower to 0.2 MPa or is 0.2 MPa shifted gas directly produced by the natural gas catalytic reforming reaction unit. The shifted gas enters the FTrSRMPSA-ERP system, a vacuumizing system where the outlet end of the adsorption tower and the vacuum pump are connected by an external pipeline is additionally arranged, and the CO₂ adsorption tower is omitted. The rotating speed ω₂ of the ring-shaped rotary tray in the system is adjusted to 0, i.e., the ring-shaped rotary tray does not rotate. The rotating direction of the 7-channel rotary valve remains the anticlockwise direction, and the rotating speed ω₁ thereof is adjusted to 200-300 s. The initial positions of the 4 adsorption towers are consistent with that in embodiment 1 but are stationary. The 7-channel rotary valve rotates anticlockwise periodically (at a constant speed) to step and are switched periodically (at a constant speed) alternatively, so that each adsorption tower experiences the conversion reaction-adsorption and desorption closed-loop cyclic operation steps of conversion reaction-adsorption (CR-A)-depressurization (D)/vacuumizing (V)-vacuumizing purge (VP)-final repressurization (FR). The purge gas (P) is overheated steam under pressure outside the system at 140-150° C. Vacuumizing purge (VP) is performed after the adsorption tower is vacuumized and desorbed. The formed vacuumizing purge waste gas (VPW), together with, the depressurization gas (D) and the vacuumizing desorption gas (VD), serves as the desorption gas (D). The desorption gas subjected to heat exchange and cooling by the heat exchanger 2 enters the desorption gas (D) buffer tank and then enters the condenser for condensing. The generated condensate water subjected to heat exchange heating by the heat exchanger 1 and the H₂ product gas (H₂PG) enters the steam boiler. The formed steam, together with the feed gas, through the superheater enters the system for the closed-loop cyclic operation of conversion reaction-adsorption and desorption regeneration. 1 channel (for example, m=4) of the 7-channel rotary valve is an empty channel, which is used correspondingly in the vacuumizing step. All material gases and process gases are uniformly and alternatively distributed in 7 round channels in the rotary valve and the built-in pipeline in the ring-shaped rotary tray and the adsorption towers in the system, and the steps in the conversion reaction adsorption and desorption process are performed on PSA of one cyclic period simultaneously through the adsorption towers on the rotating rotary valve (ω₁) and the connected ring-shaped rotary tray (ω₂=0) which is correspondingly stationary. The positions of the process gases coming in and going out of the adsorption towers change constantly according to the rotating direction and rotating speed (ω₁) of the 7-channel rotary valve, so that each adsorption tower can repeat the conversion reaction-adsorption and desorption step. Equivalently, each fixed bed adsorption tower without rotation completes respective conversion reaction-adsorption and desorption steps in the process that the 7-channel rotary valve rotates to further form the “simulated rotated moving bed” pressure swing adsorption enhanced reaction process. Therefore, the product H₂ is obtained from the shifted gas containing H₂/CO/CO₂/H₂O/CH₄. The purity of the product is greater than or equal to 99.9%, and the yield thereof is greater than or equal to 92%.

Apparently, the embodiments described above are merely some, rather than, all of the embodiments of the disclosure. Based on the embodiments recorded in the disclosure, all other embodiments obtained by persons skilled in the art without making creative efforts or structural changes made under enlightenment of the disclosure with same or similar technical solutions of the disclosure shall fall within the protection scope of the disclosure.

What is claimed is:

1. A full temperature range simulated rotated moving pressure swing adsorption (FTrSRMPSA) enhanced reaction hydrogen generation process from a shifted gas, wherein the full temperature range simulated rotated moving pressure swing adsorption enhanced reaction process (FTrSRMPSA-ERP) system is formed by n (a natural number in a range of 2≤n≤10) adsorption reactors (towers) loaded with a medium-low temperature shift catalyst and a compound adsorbent blended in a certain proportion, having axial flow fixed bed adsorption reactors (towers) with a certain height-diameter ratio and placed on a ring-shaped rotary tray at a rotating speed (ω₂, in second(s)/r), an m (a natural number in a range of 5≤m≤36)-channel rotary valve, placed at a center of the ring-shaped rotary try and rotating at a rotating speed (ω₁, in second(s)/r), a material pipeline where material gases outside the rotary valve and a system come in and go out, a process pipeline connected from a built-in pipeline of the ring-shaped tray to a position between the adsorption reactors (towers) and the rotary valve, and a driving mechanism correspondingly driving the ring-shaped rotary tray and the rotary valve in rotating directions and regulating rotating speeds (ω₁ and ω₂) thereof, a buffer tank, a condenser/or heat exchanger/or superheater/or pressurizer/or vacuum pump, wherein the pipeline connecting inlets and outlets of the adsorption reactors (towers) and an inlet and an outlet of the m-channel rotary valve is connected to the built-in pipeline pre-arranged in the ring-shaped rotary tray to form the process pipeline and has the same number m as that of the channels of the rotary valve; positions of the material gas coming in and going out of the FTrSRMPSA-ERP system are fixed by distributing the rotary channels of the m-channel rotary valve, the material gases thereof comprise a shifted gas as a feed gas (F), an H₂ product gas (H₂PG), a purge gas (P) outside the system, a final repressurization gas (FR) outside the system, and a desorption gas (D) formed by a depressurization gas (D) or/and a vacuumizing gas (V) or/and a purge waste gas (PW) and are correspondingly connected to devices comprising the buffer tank, condenser/or heat exchanger/or superheater/or pressurizer/or vacuum pump; the position where the process gases flow in the process pipeline connected through the built-in pipeline in the ring-shaped rotary tray between the inlet and outlet of the m-channel rotary valve and the inlets and outlets of the adsorption reactors (towers) changes alternately in a mobile manner;
the process gases flow in the FTrSRMPSA-ERP system, comprising the feed gas (F), a pathwise pressure release gas (PP), the purge gases (P) inside and outside the system, an equalization drop gas (ED), the desorption gas (D) formed by the depressurization gas (D) or/and the vacuumizing gas (V) or/and the purge waste gas (PW), an equalization rise gas (ER), the final repressurization gas (FR), and the product hydrogen (H₂PG); a cyclic process of specific conversion reaction-adsorption and desorption is as follows: the feed shifted gas (F) outside the FTrSRMPSA-ERP system enters feed gas (F) inlets of the multi-channel rotary valve, and enters a conversion reaction-adsorption (CR-A) step from bottoms of the adsorption reactors (towers) through the process pipeline connected to the feed gas (F) channels and the outlet of the rotary valve, the built-in pipeline of the ring-shaped rotary tray, and corresponding inlets of the one or more axial flow fixed adsorption reactors (towers) in a conversion reaction-adsorption (CR-A) state on the ring-shaped rotary tray; as continuously stepped in a matched manner by regulating the rotating direction and the rotating speed (ω₁) of the m-channel rotary valve and the rotating direction and the rotating speed (ω₂) of the ring-shaped rotary tray, non-adsorbed phase gases flowing out from tops of the adsorption reactors (tower) just enter channels of the H₂ product gas (H₂PG) of the m-channel rotary valve through the process pipeline and flow out from the channel of the H₂ product gas (H₂PG) of the rotary valve to form the H₂ product gas (H₂PG) that enters the H₂ product gas buffer tank and is then outputted; after the conversion reaction-adsorption (CR-A) step is completed by the adsorption reactors (towers) in the conversion reaction-adsorption (CR-A) state, as the m-channel rotary valve and the ring-shaped rotary tray rotate continuously to step, and/or the adsorption reactors (towers) after the conversion reaction-adsorption (CR-A) perform a pathwise pressure release (PP) or equalization drop (ED) step on one or more adsorption reactors (towers) in a purge (P) or equalization rise (ER) state through the process pipeline inside the system; the adsorption reactors (towers) after the pathwise pressure release (PP) or equalization drop (ED) step enter a depressurization (D) or/and vacuumizing (V) or/and purge (P) step as the m-channel rotary valves and the ring-shaped rotary tray rotate continuously to step; the desorption gas (D) formed by the depressurization gas (D) or/and vacuumizing gas (V) or/and purge waste gas (PW) flowing out from the adsorption towers flow out through the built-in pipeline or an external pipeline of the ring-shaped rotary tray and depressurization gas (D)/vacuumizing gas (V)/purge waste gas (PW) channel of the rotary valve and the outlet end thereof and flow through the desorption gas (D) buffer tank, and the desorption gas (D) is a CO₂-enriched gas, or the desorption gas directly enters the condenser to remove a water and co-produce high concentration CO₂, or enters a decarburization and H₂ recovery step, or returns to a natural gas/light hydrocarbon steam reforming reaction to a step of preparing the shifted gas or feed gas as carbon-hydrogen ratio adjustment; the adsorption reactor (tower) after the depressurization (D) or/and vacuumizing (V) or/and purge (P) step enters an equalization rise (ER) or waiting area (-) step as the m-channel rotary valve and the ring-shaped rotary ring rotate continuously to step; the process gases flow out from the adsorption reactor (tower) in the ED step and enter the adsorption reactor (tower) in the ER step through the built-in pipeline of the ring-shaped rotary tray and the ED channel of the rotary valve for equalization, so that the adsorption reactor (tower) in the ER or/and waiting area (-) step is finished till the pressure of the adsorption reactor (tower) in the ER step is equal to the pressure in the adsorption reactor (tower) in the ED step, and enters a final repressurization (FR) step as the m-channel rotary valve and the ring-shaped rotary ring rotate continuously to step; the H₂ product gas (H₂PG) or the feed shifted gas (F), as the final repressurization gas (FR), flow through the FR channels of the m-channel rotary valves and the built-in pipeline of the ring-shaped rotary tray to enter the adsorption reactors (towers) for pressure inflation till the pressure in the adsorption reactor (tower) reaches the conversion reaction-adsorption pressure needed by the CR-A step, and a cyclic operation of conversion reaction-adsorption and desorption next round is prepared; each adsorption reactor (tower) performs one or more step and each step and is matched by regulating the rotating direction and the rotating speed (ω₁) of the m-channel rotary valve and the rotating direction and the rotating speed (ω₂) of the ring-shaped rotary tray, so that the m channels in the rotating m-channel rotary valve are connected to time scales in the cyclic operation of conversion reaction-adsorption and desorption of the n rotating adsorption reactors (towers) in the ring-shaped rotary tray end to end to form a circle, and integrally form operating cyclicity of the conversion reaction-adsorption and desorption process of the PSA enhanced reaction; all material gases and process gases are uniformly and alternately distributed in m round (slotted) channels in the m-channel rotary valve and the built-in pipeline in the ring-shaped rotary tray and the adsorption reactors (towers) in the system, in the PSA enhanced reaction process of one cyclic period, the steps in the conversion reaction-adsorption and desorption process are simultaneously performed on the adsorption reactors (towers) on the rotating m-channel rotary valve (ω₁) and the correspondingly rotating adsorption reactors (towers) on the ring-shaped rotary tray (ω₂) connected, respectively; the positions of the process gases coming in and going out of the adsorption reactors (towers) change constantly by matching the rotating direction and the rotating speed (ω₁) of the m-channel rotary valve and the rotating direction and the rotating speed (ω₂) of the ring-shaped rotary tray, so that each adsorption reactor (tower) repeats the conversion reaction-adsorption and desorption step, and equivalently, each fixed bed adsorption reactor (tower) completes respective conversion reaction-adsorption and desorption step while the m-channel rotary valve and the ring-shaped rotary tray rotate, so as to form “a simulated rotated moving bed” PSA enhanced reaction process; and therefore, the product H₂ product gas (H₂PG) is obtained from the shifted gas, wherein the purity of the gas product is greater than or equal to 99.99%, and the yield thereof is greater than or equal to 92%.

2. The full temperature range simulated rotated moving pressure swing adsorption (FTrSRMPSA) enhanced reaction hydrogen generation process from a shifted gas according to claim 1, wherein the step of regulating and matching the rotating directions of the m-channel rotary valve and the ring-shaped rotary tray and the rotating speeds thereof (ω₁ and ω₂) comprises: 1) homodromous synchronizing, wherein the m-channel rotary valve and the ring-shaped rotary tray rotate homodromously in the clockwise or anticlockwise direction and ω₁=ω₂≠0; 2) homodromous asynchronizing, wherein the m-channel rotary valve and the ring-shaped rotary tray rotate homodromously in the clockwise or anticlockwise direction and ω₁>ω₂ or ω₁<ω₂ or ω₁≠0/ω₂=0 or ω₁=0/ω₂≠0; 3) heterodromous synchronizing, wherein the m-channel rotary valve and the ring-shaped rotary tray rotate heterodromously in the clockwise/anticlockwise direction or anticlockwise/clockwise direction and ω₁=ω₂/≠0; and 4) heterodromous asynchronizing, wherein the m-channel rotary valve and the ring-shaped rotary tray rotate heterodromously in the clockwise/anticlockwise direction or anticlockwise/clockwise direction and ω₁>ω₂ or ω₁<ω₂ or ω₁≠0/ω₂=0 or ω₁=0/ω₂≠0, and preferably, in the homodromous rotation in the clockwise or anticlockwise direction in the homodromous synchronizing and homodromous asynchronizing, ω₁≠0/ω₂=0 or ω₁=0/ω₂≠0.

3. The full temperature range simulated rotated moving pressure swing adsorption (FTrSRMPSA) enhanced reaction hydrogen generation process from a shifted gas according to claim 1, wherein a combination of the closed cyclic operation step of conversion reaction-adsorption and desorption of the FTrSRMPSA-ERP system further comprises: 1-2 time pressure equalization, 1-2 batch purge, 1 time vacuumizing, 1-2 time variable temperature pressure swing adsorption of heating and cooled heat exchanging, 1 time mutual dislocation of pathwise pressure release and equalization drop, and 1 waiting area step; moreover, the number (n) of the adsorption reactors (towers) and the number (m) of the corresponding m-channel rotary valve are increased, the height (radius)-diameter ratio (h/r) of the adsorption towers is decreased, and the rotating speeds of the m-channel rotary valve and the ring-shaped rotary tray are enough high in speed or enough short in rotating period, a separation effect of products H₂ and CO₂ in a shifted gas adsorption enhanced reaction system infinitely approaches a “steady” mass transfer separation process of the moving bed, the shifted gas reaction balance tends to move toward a complete reaction direction therewith, and the purity of the H₂ product gas (H₂PG) finally obtained is greater than or equal to 99.999%, and the product yield is greater than or equal to 95%.

4. The full temperature range simulated rotated moving pressure swing adsorption (FTrSRMPSA) enhanced reaction hydrogen generation process from a shifted gas according to claim 1, wherein the shifted gas (F) as a raw material is a mixed gas formed by 30˜60% of H₂ (v), 10-20% CO (v), and 10-20% CO₂ (v) obtained by catalytically reforming or thermally cracking methane or methanol or other hydrocarbons by steam, unreacted water, hydrocarbons and other hydrocarbons or organic matter byproduct impurities, and the temperature of the shifted gas is 90-150° C., the pressure thereof is 0.2-1.0 MPa, and the flow thereof is 100-20000 Nm³/h.

5. The full temperature range simulated rotated moving pressure swing adsorption (FTrSRMPSA) enhanced reaction hydrogen generation process from a shifted gas according to claim 1, wherein the purge gas (P) is the pathwise pressure release gas (PP) inside the system or the H₂ product gas (H₂PG) outside the system, and is purged in batches through one or more holes in the channels (slots) of the m-channel rotary valve, at most 4 holes are formed, the pathwise pressure release gas (PP) inside the system is preferably taken as the purge gas (P), and the yield of the H₂ product gas (H₂PG) reaches 93% or above.

6. The full temperature range simulated rotated moving pressure swing adsorption (FTrSRMPSA) enhanced reaction hydrogen generation process from a shifted gas according to claim 1, wherein in the depressurization (D) step, desorption is performed in a vacuumizing manner; the additionally arranged vacuum pump is connected to a material flow pipeline of the m-channel rotary valve where the desorption gas flows out or is directly connected to the external pipeline connected to the outlet end of the adsorption tower on the ring-shaped rotary tray, and a control valve is arranged on the external pipeline, and preferably, the vacuum pump is directly connected to the external pipeline connected to the outlet end of the adsorption tower on the ring-shaped rotary tray and the control valve is arranged on the external pipeline.

7. The full temperature range simulated rotated moving pressure swing adsorption (FTrSRMPSA) enhanced reaction hydrogen generation process from a shifted gas according to claim 1, wherein the final repressurization gas (FR) is the feed shifted gas (F) or the H₂ product gas (H₂PG) outside the system, and under a working condition that the purity of the H₂ product gas (H₂PG) is required to be greater than or equal to 99.99%, the H₂ product gas (H₂PG) is preferably used as the final repressurization gas (FR).

8. The full temperature range simulated rotated moving pressure swing adsorption (FTrSRMPSA) enhanced reaction hydrogen generation process from a shifted gas according to claim 1, wherein the n loaded blended catalysts/adsorbents in the FTrSRMPSA-ERP system are formed by stacking ferric medium shift catalysts and lithium-carbon molecular sieves/activated carbon particles in a proportion of 1:(1-1.5) at an interval, or composite catalytic adsorbent particles of ferric active component loading carbon nanotubes (CNTs) or carbon fibers (CNFs)/activated carbon (AC)/aluminum oxide, or cellular and bundled regular composite catalytic adsorbents formed by high polymer organic matters or carbon nanotubes or carbon fibers or formed by loading ferric active components by taking silicate as a base material, and preferably, the catalysts/adsorbents are formed by stacking ferric medium shift catalysts and lithium-carbon molecular sieves/activated carbon particles in a proportion of 1:1.1 at an interval or the bundled and cellular regular composite adsorbents formed by high polymer organic matters or carbon nanotubes or carbon fibers or formed by loading ferric/lithium active components by taking silicate (containing silicon fluoride, ceramics, and glass fibers) as the base material.
